(19) United States
(12) Patent Application Publication
(10) Pub. No.: US 2006/0054805 A1
(43) Pub. Date: Mar. 16, 2006

(54) Multi-inlet sampling device for mass spectrometer ion source

(76) Inventors: Michael J. Flanagan, Sunnyvale, CA (US); Harvey D. Loucks JR., LaHonda, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/940,199

(22) Filed: Sep. 13, 2004

(51) Int. Cl. H01J 49/04

(52) U.S. Cl. 250/288

(57) ABSTRACT

The invention provides a multi-inlet sampling device for an ion source. In general, the sampling device contains at least two sample inlet capillaries and a single outlet capillary that are all fluidically connected. A mass spectrometer ion source and a mass spectrometer system containing the multi-inlet sampling device are also provided. The device is readily removed and installed at ambient pressure without venting the mass spectrometer. Also provided by the invention are methods for simultaneously introducing at least two samples into a mass analyzer.

### BACKGROUND

The combination of mass spectrometry (MS) and liquid chromatography (LC) is one of the most powerful methods available for analysis of chemical compounds and is widely used in chemical, environmental, pharmaceutical and biological research. In a liquid chromatograph, a sample containing a mixture of compounds is pumped through a separation column in a liquid mobile phase. The components of the sample mixture are separated as they pass through the column, and emerge from the column one after another. A detector is connected to the fluid stream at the column exit to detect the components as they leave the column.

In a mass spectrometer, compounds are positively or negatively charged in an ionization source. The masses of the resultant ions are determined in a vacuum by a mass analyzer that measures the mass/charge (m/z) ratio of the ions. When used as a detector for a liquid chromatograph, a mass spectrometer can provide information on the molecular weight and chemical structure of each compound separated by the chromatograph, allowing identification of each of the components of the mixture.

In many instances it is desirable to be able to use a single mass spectrometer to analyze multiple inlet streams coming from multiple LC columns or other liquid phase sample sources. In particular, it is sometimes desirable to combine compounds of known molecular mass, so called “calibration standards”, “reference mass standards” or “internal standards”, to a sample of interest prior to analysis to provide a more accurate measurement of the molecular mass of analytes in the sample. For example, it may be desirable to analyze constituents of a primary liquid stream from a chromatography system and constituents of a distinct liquid stream containing reference mass standards simultaneously. However, combining two samples just prior to ionization can have undesirable analytical consequences. For example, some components of a sample may react with or suppress ionization of other components in a sample, there may be unpredictable effects on sample transport and ionization since the samples may not be of the same type, and certain components may precipitate or become insoluble if incompatible samples are mixed. Also, the liquid streams entering an ionization source may have significantly different flow rates, and mixing of the liquid streams may decrease the resolution that was obtained by chromatographic separation.

Accordingly, a need exists for new means for combining samples prior to their amalysis by mass spectrometry.

### SUMMARY OF THE INVENTION

The invention provides a multi-inlet sampling device for an ion source. In general, the sampling device contains two sample inlet capillaries and a single outlet capillary that are fluidically connected. In certain embodiments, the inner diameter of one of the inlet capillaries is larger than the other and the larger of the inlet capillaries may be coaxially aligned with the outlet capillary. A mass spectrometer ion source and a mass spectrometer system containing the multi-inlet sampling device are also provided. Also provided by the invention are methods for simultaneously introducing at least two samples into a mass analyzer. The invention finds use in a variety of analytical methods. For example, the invention finds use in chemical, environmental, forensic, food, pharmaceutical and biological research applications. In particular the invention may be used for the mass spectrometric analysis of protein digests, including peptide mass fingerprinting (PMF) and protein sequencing applications, intact protein analysis, protein-protein or protein-ligand non-covalent complex analysis, oligonucleotide and nucleic acid analysis, for example.

### BRIEF DESCRIPTION OF THE DRAWINGS

FIGS. 1A and 1B are sectional views of a multi-inlet sampling device and other components of an ion source according to certain embodiments of the invention.

FIG. 2 is a sectional view of a multi-inlet sampling device and other components of an ion source according to certain other embodiments of the invention.

FIG. 3 is a sectional view of a multi-inlet sampling device according to certain embodiments of the invention.

FIG. 4 is a schematic representation of an embodiment of an ion mass analysis system described herein.

FIG. 5 is a base peak chromatographic plot (top), a mass spectrum (middle), and a molecular ion plot (bottom) showing exemplary results obtained using the invention described herein.

FIG. 6 shows exemplary mass measurement error results for the first four isotope peaks of the molecular ion of BSA tryptic peptide A(437-451), +3 charge state, analyzed at multiple levels by nanoelectrospray LC/API-TOF using the invention described herein.

FIG. 7 shows exemplary peptide mass measurement results obtained for nanoelectrospray LC/API-TOF analysis of multiple levels of a bovine serum albumin (BSA) tryptic digest using the invention describe herein. Peptide ion extraction, identification and mass measurement results were obtained using commercially available automated mass spectral data processing tools and protein database search software.

FIG. 8 is a molecular ion plot and table showing exemplary results for nanoelectrospray API-TOF analysis of insulin oxidized B chain in negative ion mode using the invention described herein.

### DETAILED DESCRIPTION OF THE INVENTION

The invention provides a multi-inlet sampling device for an ion source. In general, the sampling device contains two sample inlet capillaries and a single outlet capillary that are fluidically connected. In certain embodiments, the inner diameter of one of the inlet capillaries is larger than the other and the larger of the inlet capillaries may be coaxially aligned with the outlet capillary and fluidically connected thereto. In an alternative embodiment, the dimensions of the inner diameters and lengths of the inlet capillaries are suitably chosen in order to independently sample two or more sample streams at or about equal rates. A mass spectrometer ion source and a mass spectrometer system containing the multi-inlet sampling device are also provided. Also provided by the invention are methods for simultaneously introducing at least two samples into a mass analyzer.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention.

The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Multi-Inlet Sampling Devices

The invention described herein relates to a multi-inlet sampling device that may be employed in a multi-sprayer ion source for a mass spectrometer. In general terms, the device is part of an ion source and operates as an interface between the ionization source at or near ambient pressure and an intermediate region with a lower than ambient pressure. In certain embodiments, the multi-inlet sampling device facilitates combining ions prior to their transport from an ion source to a mass analyzer via a collection capillary or other orifice containing element, for example. The multi-inlet sampling device contains multiple (i.e., at least two) sample inlet capillaries that merge together to form a single capillary, termed herein a “sample outlet capillary”. As will be discussed in greater detail below, two or more samples may be introduced into the inlet capillaries (usually one sample per capillary), the samples are mixed as they are transported through the device and exit via a single outlet capillary that is near or just below ambient pressure. The exit orifice of the outlet capillary may be present within the ion source, and may be at or about ambient pressure during operation of the ion source.

The multi-inlet sampling device enables methods of combining samples that avoid spray interference and potentially inhibitory molecular interactions between ionized and/or non-ionized solutes and solvents. In certain embodiments, the device may be employed to combine samples (e.g., a sample of interest and a sample containing reference mass standards) without significantly increasing the volume of a sample of interest, without suppressing ions of interest, and without significantly diluting the ions of interest in an ionized sample prior to analysis. In addition, the device is readily installed at ambient pressure without venting the mass spectrometer. Accordingly, the invention avoids a number of problems associated with related prior art sampling devices, and, as such, provides a significant contribution to the analytical arts.

Various features of the multi-inlet sampling device are most easily described with reference to the figures. As would be apparent to one of skill in the art, the multi-inlet sampling device may contain multiple (i.e., more than two, e.g., three, four or five or more) inlet sample capillaries. However, for ease of description, the devices shown in the figures have two sample inlet capillaries. The devices shown in the figures may be readily adapted to accommodate more capillaries so as to accommodate more samples. The devices shown in the figures are also readily adaptable to accommodate microflow and nanoflow ionization devices (e.g., spray devices).

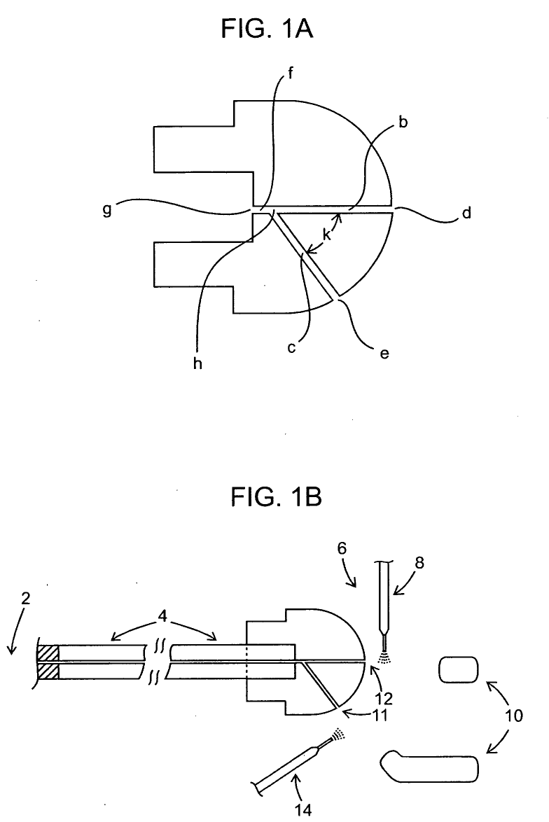

FIG. 1A shows an exemplary multi-inlet sampling device for a mass spectrometer ion source. The device shown in FIG. 1A contains a first and second sample inlet capillaries b and c and a single outlet capillary f. Each of the capillaries has a single port (i.e., opening or orifice) on the outer surface of the device, d, e and g, respectively, where the ports for the inlet capillaries (i.e., d and e) are referred to herein as inlet ports and the port for the outlet capillary (i.e., g) is referred to herein as an outlet port. The lumens of all capillaries are joined, i.e., merged, in area h to provide a fluidic connection between the capillaries. By “fluidic connection” is meant that a gas or fluid (including any compositions entrained therein, e.g., ions or droplets such as charged or non-charged droplets) can enter and be transported through the lumens of the two sample inlet capillaries and enter the lumen of the sample outlet capillary upon application of a vacuum or partial vacuum to the outlet of the sample outlet capillary.

In many embodiments, the capillaries are straight (i.e., free from curves, bends, angles, or irregularities), however, in other embodiments, the capillaries are curved. In certain embodiments the first sample inlet capillary d is coaxially aligned in tandem with the sample outlet capillary f such that the first sample inlet capillary and sample outlet capillary form a continuous linear tube (with the exception of area h in which the second sample inlet capillary is merged with that tube) that communicates one side of the device to the other. In embodiments where the first sample inlet capillary and sample outlet capillary are coaxially tandem, the second sample inlet capillary typically merges with the junction of the capillaries at angle k, relative to the longitudinal axis of the capillaries. Angle k is typically less than 90°. For example, angle k may be from 15° to 60° or, in certain embodiments 25° to 50°. In certain embodiments, the inlet capillaries merge within the multi-inlet sampling device, and the outlet capillary may be 0.1 cm to 10 cm in length, e.g., 0.2 cm to 3 cm or 0.3 cm to 2 cm in length. In certain embodiments, the inlet capillaries may merge at the surface of a the multi-inlet sampling device.

In certain embodiments, the second sample inlet capillary has a lumen diameter, i.e., inner diameter, that is smaller than that of the first sample inlet capillary and therefore has a lower gas flow rate than the first sample inlet capillary (provided the capillaries are of equal length). In these embodiments, the diameter of the lumen of the second sample inlet capillary is less than or equal to about 70% of the diameter of the lumen of the first sample inlet capillary. For example, the diameter of the lumen of the second sample inlet capillary may be less than about 60%, less than about 50%, less than about 40%, less than about 30%, less than about 20%, or less than about 10%, and typically greater than about 5%, 10% or 20% of the diameter of the lumen of the first sample inlet capillary. In certain embodiments, therefore, if the first sample inlet capillary lumen has a diameter of 0.5 mm to 0.8 mm, the second sample inlet capillary lumen may have a diameter of 200 μm to 425 μm, or less. In particular embodiments, a first sample inlet capillary lumen has a diameter of about 0.8 mm and the second sample inlet capillary lumen may have diameter of about 330 μm (22 gauge) or 410 μm (23 gauge).

The second sample inlet capillary is longer, shorter, or the same as the length of the sample inlet capillary. In certain embodiments, the length of the second capillary may be about 30%, about 50%, about 70%, about 80%, about 90%, about 100%, or about 150% of the length of the first inlet capillary.

In use, the difference in lumen diameters of the first and second sample inlet capillaries provides a reduced gas flow rate in the second sample inlet capillary, as compared to that of the first sample inlet capillary. In many embodiments, the gas flow rate of the second sample inlet capillary is less than about 20%, e.g., less than about 15%, less than about 10%, less than about 5%, less than about 3%, less than about 2% and more than about 1%, of the flow rate of the first sample inlet capillary. For example, second sample inlet capillaries having lumen diameters of 330 μm and 410 μm have flow rates that are about 1/17^{th} and about 1/7^{th} of the flow rate of a first sample inlet capillary having a lumen diameter of about 0.8 mm, respectively, when the first inlet capillary is twice the length of either of the second sample inlet capillaries. In general, the diameter of the. second sample inlet capillary is minimized without restricting gas flow to such an extent that ions passing through the capillary are undetectable. In certain embodiments, the gas flow rate of the sample outlet capillary may be between about 0.5 L/min and about 3 L/min, although larger or smaller gas flow rates are routinely used in certain applications. In other words, capillary diameters may be adjusted according to the desired application for the sampling device. Since the flow rates of samples introduced to the multi-inlet sampling device may be different, the diameters of the inlet capillaries for those samples may be the different. For example, the flow rate of one of the liquid sample streams may be as low as 20 nl/min while the flow rate of another liquid stream may be much greater, e.g., 300 nl/min. In other words, the inner diameters and lengths of the inlet capillaries may be chosen to accommodate the flow rates of the incoming sample streams.

In certain embodiments, the lumen diameter of the first sample inlet capillary is the same as the lumen diameter of the second inlet capillary, and, accordingly, the gas flow rates through those capillaries will be the same provided the capillaries are of the same length.

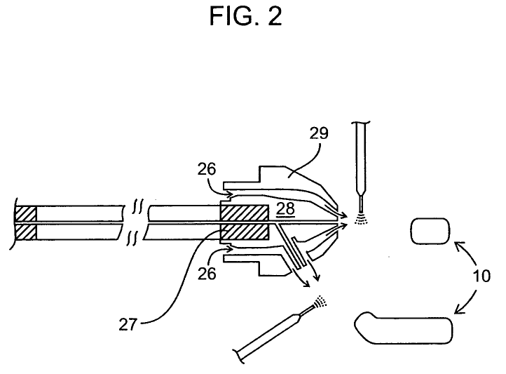

In, certain embodiments of particular interest, the multi-inlet sampling device also contains at least one counter-current drying gas nozzle, i.e., an element for delivering a drying gas, typically heated ultra-high purity nitrogen, to the sample spray regions within an ion source to aid in desolvation of the sample. As illustrated in FIG. 2, such nozzles typically direct drying gas 26 to a position proximal to the inlet of a sample inlet capillary. In certain embodiments, the multi-inlet sampling device contains a counter-current drying gas nozzle for each sample inlet capillary of the device. However, in certain other embodiments, only the first sample inlet capillary may be associated with a counter-current drying gas nozzle. The nozzle typically comprises an inner element or “cone” and an outer element or “cone” that surround the entrance to a sample inlet capillary. The drying gas is delivered through a nozzle in the counter direction (i.e., opposite direction) to that of the ion flow in the inlet capillary, and assists in desolvation of the sample prior to and during its entry into the inlet capillary. In the embodiment shown in FIG. 2, drying gas is supplied to regions immediately outside of both of the inlet capillaries. Since different samples may require different levels of drying gas to assist desolvation, flow of the drying gas through the nozzles may be regulated using a gas regulator element (e.g., a restrictor). In certain embodiments, the gas regulator element may be a perforated collar (e.g., a ring with bores, i.e., holes) that fits into the nozzle to regulate gas flow through the nozzle. The amount of drying gas passing through a nozzle can be changed by exchanging a collar with another collar with larger, smaller, more or less perforations, for example. Each nozzle may have a regulator element, and the regulator element in each nozzle of the multi-inlet sampling device may allow different amounts of drying gas to exit each of the device's nozzles. If ionization of a sample occurs using APCI, APPI, or electron impact methods, then less drying gas may be supplied to the ionized sample, as compared to samples ionized by other methods. In certain embodiments, in order to aid desolvation, heat may be supplied to an ionization region proximal to the entrance orifice of one or more (or all) of the inlet capillaries of the multi-inlet sampling device by means other than a counter-current drying gas nozzle. Accordingly, samples may be desolvated by other means than a counter-current drying gas, and there is no requirement for any counter-current drying gas nozzle in the multi-inlet sampling device. For example, in certain embodiments of the invention, heated drying gas may be supplied to the droplets produced by a sprayer by a capillary (e.g., a heated ceramic or quartz tube that may be heated) that is separate to the sample device and aimed towards a region containing the sample droplets. In these embodiments, the sprayer employed may be an electrospray nebulizer that utilizes heated nitrogen gas to nebulize the sample. The flow rate of such a nebulizer may be up to 1 ml/min or greater. In other embodiments, heat may be radiated onto the droplets produced by a sprayer (e.g., using a quartz infra-red (IR) heater), and, as such, the sample may desolvate without the need for a drying gas supplied via a counter-current nozzle. Accordingly, while each inlet capillary orifice of the multi-inlet sampling device may be associated with a counter-current drying gas nozzle, devices having inlet capillaries that are not associated with counter-current drying gas nozzles are operable and may be readily employed as components of an ion source.

In certain embodiments, the sample outlet capillary of the multi-inlet sampling device may be adapted for connection to the orifice of a transfer capillary (shown as element 4 of FIG. 1B) such that lumen of the transfer capillary is in fluid connection with the sample outlet capillary lumen. The transfer capillary typically has a lumen diameter that is equal to or smaller than the lumen diameter of the sample outlet capillary of the multi-inlet sampling device. In many embodiments, the transfer capillary is between 5 cm and 30 cm in length, e.g., about 18 cm, and serves to transport ions and assist desolvation of ion clusters that exit from the outlet capillary at about or just below ambient pressure 6 (approximately 500-760 torr) to an intermediate vacuum chamber 2 of, e.g., of 1-10 torr. Accordingly, the multi-inlet sampling device is typically not in direct physical connection with a vacuum region. As ions are transported down the transfer capillary they experience drop in pressure from about ambient pressure as they exit the sample outlet capillary and enter the transfer capillary, to less then about 10 torr, e.g., 2-3-torr, as they exit the transfer capillary. The ionized samples are combined at near or just below ambient pressure, not in a vacuum. Transfer capillaries are typically made from a dielectric material, e.g., glass, however transfer capillaries made from other materials, e.g., metal, are also envisioned. A sample may further desolvate as it passes through the transfer capillary. As indicated by element 27 in FIG. 2, in certain embodiments, the end of a transfer capillary that is coupled With the multi-inlet sampling device may be coated (e.g., plated or sputtered) with gold, platinum, rhodium or suitable corrosion-resistant metal or alloy. In certain embodiments, the transfer capillary may be heated.

In certain embodiments, instead of a transfer capillary, the multi-inlet sampling device may be adapted for connection (i.e., is connectable) to an orifice-containing element so that the lumen of the outlet capillary is in fluid connection with the orifice, allowing an ionized sample to pass through the orifice as it exits the device. The multi-inlet sampling device may be connectable to the orifice in a wall of the ion source of a mass spectrometer system. The orifice may be in a wall that separates the ion source from a second chamber, e.g., a vacuum stage, of a mass spectrometer system. In these embodiments, ions may exit the multi-inlet sampling device via the device's outlet capillary, pass through the orifice, and enter the second chamber. The second chamber may contain a skimmer which results in enrichment of analyte ions (relative to the lighter solvent ions and gas) and provides ion transport means (due to the pressure differential between the two adjoining regions), and other ion transport devices, e.g., a multipole ion guide or the like, for transporting the ions through the second chamber. In these embodiments, the chamber wall may be a double walled chamber or “curtained” chamber and a drying gas may be pumped into the space between the walls.

The body of a multi-inlet sampling device, including any nozzles, may be made from any suitable material. Suitable materials are generally non-corrosive and can withstand moderate heat without outgassing. Suitable materials can act as an electrode and may be fabricated (e.g., machined) to the specifications described above. Accordingly, the body of the multi-inlet sampling device may be made from an alloy such as stainless steel or a superalloy, for example, although other materials can be readily used. High temperature insulators for example thermoplastic polyimide VESPEL™ and polyetheretherketone (PEEK), may be used to isolate voltages that are in close proximity. Sample inlet and/or outlet capillaries may be fabricated from an alloy such as stainless steel, however, glass-lined (quartz) stainless steel, PEEK, or other compatible materials could be used provided that ions can be drawn via an electric potential to their respective inlets.

A feature of many multi-inlet sampling sampling devices is that they are configured to be operatively connected to a transfer capillary of an ion source, as indicated above. Accordingly, the multi-inlet sampling devices may include a mating region that securely fits, i.e., stably associates, the sampling device to a transfer capillary, e.g. so that the outlet capillary and the transfer capillary are aligned, as described above. Where desired, a sealing element may be employed in mating the sampling device to the transfer capillary. Since the exit orifice of the outlet capillary is near or just below ambient pressure during operation of a mass spectrometer system in which the multi-inlet sampling device is employed, the multi-inlet sampling device may be detached and re-attached, or replaced with a second multi-inlet sampling device or other sampling device, without venting of any chambers adjacent to the device into which the multi-inlet sampling device (or any transfer capillary attached thereto) feeds.

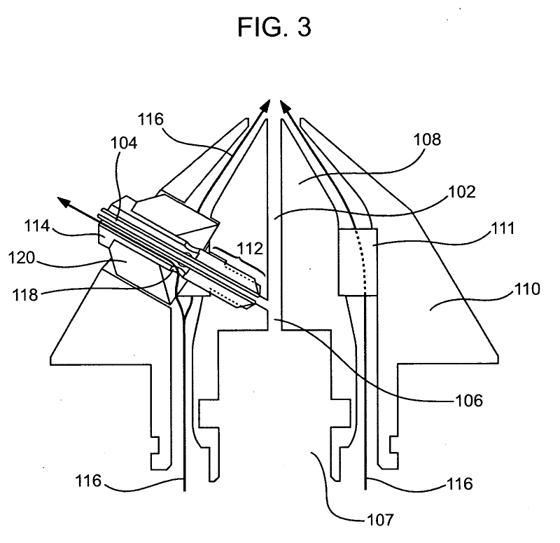

In representative embodiments and in the orientation shown in FIG. 3, the multi-inlet sampling device has an overall height of from about 1 cm to about 5 cm, such as from about 2 cm to about 4 cm; an overall width of from about 1 cm to about 5 cm, such as from about 2 cm to about 4 cm and an overall depth of from about 1 cm to about 5 cm, such as from about 2 cm to about 4 cm.

Mass Spectrometer Ion Sources

The invention also provides a mass spectrometer ion source containing the multi-inlet sampling device. In general, the ion source contains a sprayer for each sample inlet-capillary of the sampling device described above. Exemplary ion sources containing the multi-inlet sampling device are shown in FIG. 1B. FIG. 2 shows an ion source identical to that shown in FIG. 1, except the multi-inlet sampling device contains counter-current drying gas nozzles.

Sample sprayers are conventional in the art and generally include nanosprayers (having a flowrate of approximately 20-500 nl/min, e.g., 20-80 nl/min or 100-500 nl/min), microsprayers (having a flowrate of approximately 1-50 μl/min, e.g., 4-20 μl/min) and other sprayers that have a flow rate between those of the nano and microsprayer. Exemplary spray devices (which term includes sample nebulizers) may be found in ESI, APCI, and APPI ion sources, as well as a variety of other types of ion source. In particular embodiments, a sample sprayer used in the device may have a flow rate of 280-320 nl/min, particular if an LC column having an internal diameter of 75 μm is employed. Also as is well known in the art, an ion source may contain an electrospray ionization (ESI) device, an atmospheric pressure chemical ionization (APCI) device, an atmospheric pressure photoionization (APPI) device, or any combination thereof (to provide a so-called “multimode” ionization source). An ion source may contain any one type of sample sprayer, or a mixture of different types of sample sprayer. Sprayers of interest include PICOTIP™ sprayers, microfabricated “chip” devices with integrated spray nozzles and microflow sprayers. In certain other embodiments, higher-flow sprayers having flow rates of up to 20 μl-5 ml/min (e.g., about 1 ml/min) may be employed in the multi-inlet sampling device.

Referring to FIG. 1B, any suitable ionization method may be used to ionize the sample in the fluid streams as long as the ions generated from each fluid stream are capable of entering inlets 11 and 12 and do not become cross-contaminated, i.e., the sprays do not intersect. Accordingly, the sample sprayers are distanced from each other to avoid cross-contamination (i.e., any physical or chemical impairment due to spray interference) between the sprays produced. In certain embodiments, sprayers 11 and 12 are coaxial pneumatic nebulizers that utilize an electrospray method for ionization. In these sprayers a high electric field gradient at the end of a hollow needle charges the surface of the fluid stream as it exits the needle, and an inert gas with a high flow rate passes through a hollow outer tube surrounding the needle to assist nebulization of the liquid. Other possible ionization methods include atmospheric pressure chemical ionization (APCI), atmospheric pressure photoionization (APPI) and inductively coupled plasma (ICP) ionization.

The ion source shown in FIG. 11B illustrates sprayers 8 and 14 arranged at an approximate 90° angle to the longitudinal axis of their respective inlet capillaries, i.e., orthogonally thereto. However, as is well known in the art, sprayers can be oriented at other angles, including at 180°, or any angle therebetween (see U.S. Pat. No. 6,649,908), for example. A sprayer may be rotatable around the longitudinal axis of an inlet capillary for that sprayer. In certain embodiments, the sprayers may be aimed directly at the sample inlet capillary entrances.

The ion source may also optionally contain one or more electrodes 10 to facilitate transfer of ions into the sample inlet capillaries. The electrode voltages may vary greatly depending on the sampling device used (and voltage applied thereto) and the charge of the ions under study (i.e., whether they are positively or negatively charged). Such electrodes are conventional in the art and need not be described herein in any further detail.

In certain embodiments discussed above, the multi-inlet sampling device may contain nozzles for supplying drying gas to a region proximal to the orifice(s) of one or more inlet capillaries (as indicated by the arrows in FIG. 2). In such embodiments, and referring to FIG. 2, the outer element 28 (the “outer cone”) of the multi-inlet sampling device may be at a voltage that is different to the voltage of the inner element 29 (the “inner cone”) of the device. If positively charged ions are under study, the inner element may have a voltage that is of a greater magnitude than the voltage of the outer element (e.g., −400V to −600V greater or about −500V relative thereto). Similarly, if negatively charged ions are under study, the inner element may have a voltage that is of a greater magnitude than that of the outer element (e.g., +400V to +600V greater or about +500V relative thereto). In certain embodiments, the magnitude of the voltages employed may range from 1.3 kV to 3.0 kV, e.g., 1.7 kV to 2.5 kV. The inner and outer elements may be electrically insulated from each other. If electrodes are employed in an ion source with the multi-inlet sampling device that contains counter-current drying gas nozzles, the electrodes are generally employed at a voltage that is similar to or the same as the voltage of the outer element of the nozzle (i.e., + or −400V to 600V of the voltage of the inner nozzle element, depending on the polarity of the ions under study).

If positively charged ions are of interest, therefore, an inlet.orifice of the multi-inlet sampling device may be at, for example, −1.7 kV to −2.5 kV, and its respective sample sprayer may be at or near ground potential. If one or more additional electrodes are employed within the multi-inlet ion source (e.g., electrodes 10 in the device shown in FIG. 1B), they may be at or near the same voltage as the outer element (e.g. −1.3 kV to −2.1 kV or about 400-600 volts lower in magnitude than the inner element). Similarly if negatively charged ions are of interest, an inlet orifice of the multi-inlet sampling device may be at, for example, +1.7 kV to +2.5 kV, and its respective sample sprayer may be at or near ground potential. If one or more additional electrodes are employed within the multi-inlet ion source (e.g. electrodes 10 in the device shown in FIG. 1B), they may be at or near the same voltage as the outer cone (e.g. +1.3 kV to +2.1 kV) or about 400-600 volts lower in magnitude than the inner element of the cone. Alternatively, a reversed electrical field geometry may be employed in which the sprayers are held at high voltage (e.g. 1.5 kV to 6.0 kV in magnitude) and the inlet capillaries are held at or near ground potential. Both geometries provide a net voltage potential that moves charged ions of a particular polarity towards the inlet orifice the device.

FIG. 3 shows a representitive embodiment of a multi-inlet sampling device according to the present invention. The device shown in FIG. 3 contains a first inlet capillary 102, second inlet capillary 104 and outlet capillary 106, as described above, and is adapted for connection to another orifice-containing element, e.g., a transfer capillary, by element 107. The device shown in FIG. 3 contains an inner element 108 (also termed an “inner cone”) and an outer element 110 (also termed an “outer cone”) that are electrically insulated from each other (and held in place relative to each other) by insulator elements 111 and 120. The second inlet capillary is in electrical connection with inner element 108 and insulated from outer element 110. Second inlet capillary 104 may be held in place in the device by sheathing 114. Elements 111 and 120 may be collars that surround elements 108 and 114 and hold them in place. As indicated by reference numeral 118, sheathing 114 may contain at least one aperture (e.g., a hole) to allow drying gas therethrough. Sheathing 114 may be attached to the device via an attachment element 112, which, in certain embodiments may be a screw thread or the like. Sheathing element 114 may be detachable from the the multi-inlet sampling device and re-attached to the device via attachment element 112. Sheathing elements containing inlet capillaries of different bores may be exchanged in the the multi-inlet sampling device using attachment element 112. Sheathing element 112 may be connected to inlet capillary 104 by any type of fitting, e.g., a friction fitting. In particular embodiments, sheathing 114 may be metal and may be electrically connected to the outer element 110. In these embodiments, the second inlet capillary 104 may be electrically connected to inner element 108 and insulated from sheathing 114. In alternative embodiments, however, elements 114 and 108 may be electrically connected to each other.

In use and as described above, outer element 110 of the multi-inlet sampling device may be maintained at a voltage that is higher or lower (e.g., 400V to 600V higher or lower) than the voltage of inner element 108 (depending on the ions under study) in order to preferentially attract ions to the inlet capillaries. As indicated by the arrows, drying gas 116 enters the device and moves through conduction elements to exit the device at positions immediately adjacent to the orifices of the inlet capillaries. In certain embodiments, insulator element 111 contains bores (i.e. holes or apertures that lead from one side of the element to the other) to allow (and regulate) gas flow to the first inlet capillary orifice. Drying gas 116 enters a void between capillary 104 and sheathing 114 via one or more bores (i.e., holes) 118 and exits at the orifice of inlet capillary 104.

Mass Spectrometer Systems

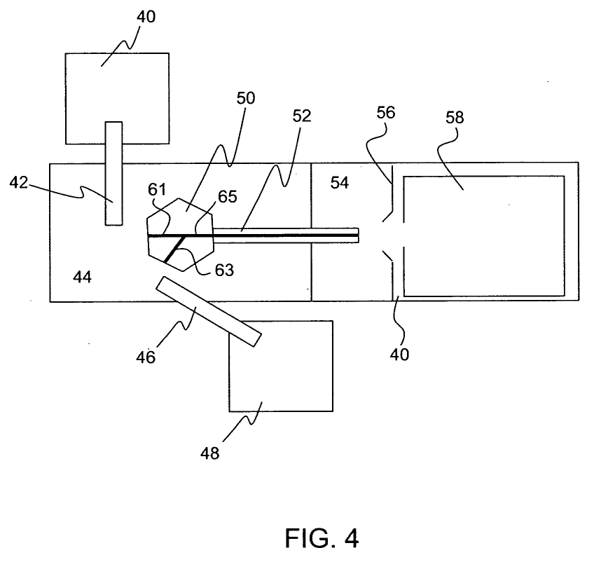

The invention also provides a mass spectrometer system containing an above-described ion source. An exemplary mass spectrometer system is shown in FIG. 4. In general terms, a mass spectrometer system contains an ion source 44 containing at least two ionization devices 42 and 46 and a multi-inlet sampler 50, as described above, and a mass analyzer 58. As is conventional in the art, the ion source and the mass analyzer are separated by one or more intermediate vacuum chambers 54 into which ions are transferred from the ion source 44 via an above-described transfer capillary 52 (or, in alternative embodiments, via an orifice in a wall separating the chambers). Also as is conventional in the art, the intermediate vacuum chamber may also contain a skimmer 56 to enrich analyte ions (relative to solvent ions and gas) contained in the ion beam exiting the transfer capillary prior to its entry into the ion transfer optics (e.g., an ion guide, or the like) leading to a mass analyzer in high vacuum 58.

A variety of different mass analyzers may be a part of the above described system, including time of flight (TOF), Fourier transform ion cyclotron resonance (FTICR), ion trap, quadrupole or double focusing magnetic electric sector mass analyzers, or any hybrid thereof.

In certain embodiments, an ion source of a mass spectrometer system may be connected to devices 40 and 48 for providing liquid streams to the sample sprayers. In many embodiments, at least one of those devices is an analytical separation device such as a liquid chromatograph (LC), including a high performance liquid chromatograph (HPLC), a micro- or nano-liquid chromatograph and an ultra high pressure liquid chromatograph (UHPLC) device, a capillary electrophoresis (CE), or a capillary electrophoresis chromatograph (CEC) device, however, any manual or automated injection or dispensing pump system may be used. In particular embodiments, a liquid stream may be provided by means of a nano- or micropump, for example.

In use, ion source 44 is held at ambient pressure, intermediate chamber 54 is held at a pressure that is around two orders of magnitude less than the ambient pressure, and mass analyzer 58 is held at a pressure of around two to four orders of magnitude less than that of the intermediate chamber. Ions leaving first and second sample sprayers 42 and 46 are directed to or attracted towards the first and second sample inlet capillaries 61 and 63 of the multi-inlet sampling device, respectively, where they enter their respective capillaries and are combined within the multi-inlet sampling device at or near ambient pressure and exit the device (near or just below ambient pressure) via sample outlet capillary 65. The combined ions enter the transfer capillary 52 and are swept into the first vacuum chamber 54 in a stream of gas due to the pressure difference between ion source 44 and chamber 54. The ions exit the transfer capillary 52 and pass through skimmer 56 (and any ion guide, ion beam shaping or focusing lenses present) to focus and direct the ions into a mass analyzer 58. Mass analyzer 58 determines the m/z ratio of the ions, and thus is useful for determining molecular weights of analytes in the samples.

In an exemplary embodiment, a first liquid containing a sample of interest is provided to the first sample sprayer 42 of the ion source by an analytical separation device such as an LC. A second liquid containing reference mass standards dissolved in an appropriate solvent, e.g., an organic solvent, is continuously pumped to the second sample sprayer 46. Both liquids are supplied to their respective sample sprayers as a continuous stream and ionized thereby. The first and second ionized samples flow into the first and second sample inlet capillaries 61 and 63, respectively, and are combined together in the multi-inlet sampling device 50, swept into the first vacuum chamber 54 via transfer capillary 52 and skimmer 56, transported through an ion guide and/or any beam shaping optics that may be present, and subsequently analyzed by the mass analyzer 58 as discussed above. If a multi-inlet sampling device containing different sized sample inlet capillaries is used, the sample containing reference mass standards typically enters the smaller of the two capillaries.

The invention finds use in methods of sample mass analysis, where a sample may be any liquid material (including solubilized or dissolved solids) or mixture of materials, typically, although not necessarily, dissolved in a solvent. Samples typically contain one or more components of interest. Samples may be derived from a variety of sources such as from foodstuffs, environmental materials, a biological sample such as tissue or fluid isolated from a subject (e.g., a plant or animal subject), including but not limited to, for example, plasma, serum, spinal fluid, semen, lymph fluid, the external sections of the skin, respiratory, intestinal, and genitourinary tracts, tears, saliva, milk, blood cells, tumors, organs, and also samples of in vitro cell culture constituents (including but not limited to conditioned medium resulting from the growth of cells in cell culture medium, putatively virally infected cells, recombinant cells, and cell components), or any biochemical fraction thereof. Also included by the term “sample” are samples containing calibration standards or reference mass standards.

In many embodiments, the methods involve a) ionizing at least two samples in an ion source containing the multi-inlet sampling device and a sample sprayer for each inlet, as described above, b) introducing the ionized samples into the inlet capillaries, c) combining the ionized samples within said sampling device at about ambient pressure, and d) simultaneously introducing the combined ionized samples into a second chamber, e.g., a chamber of intermediate vacuum, via a transfer capillary or other means, e.g., an orifice in the wall of the chamber.

The invention enables the straightforward addition of reference mass standards to a sample of interest so that the molecular masses and fragments of components within the sample of interest can be determined with a high degree of mass accuracy. Accordingly, the invention may be employed in a variety of mass analysis determinations, including the analysis of complex mixtures of peptides or protein digests, analysis of intact proteins or complexes thereof, and nucleic acid analysis, and the like. In certain embodiments, the reference mass standards may be supplied (e.g., delivered or sprayed) alone or in a mixture at a concentration in the range of about 0.1-1 μMolar, employing a commercially available nanofluidic delivery module (e.g. a syringe pump).

In one embodiment, a Zorbax 300SB-C18, 3.5 μm, 50×0.075 mm i.d. capillary column may be used for nanospray analysis of protein digests at a flowrate of 300 nl/min and a Zorbax 300SB-C18, 5 μm, 250×0.3 mm i.d. capillary column may be used for the same analysis at 4.5 μl/min (microflow) flowrate.

Kits

Kits for use in connection with the invention may also be provided. Such kits include any of the compositions, including a multi-inlet sampling device, as discussed above. The kit may also contain instructions for installing a the multi-inlet sampling device in a multi-sprayer ion source, instructions for retrofitting a multi-sprayer ion source with the multi-inlet sampling device, or instructions for performing any of the above methods, where the instructions are typically present on a substrate, e.g., one or more sheets of paper, associated with the kit. The kit may also include one-or more reference mass standards that, in certain embodiments, may be present as a mixture or in separate vials.

In addition to above-mentioned components, the kit may further include instructions for using the components of the kit to practice the methods. For example, information on the reference mass standareds (e.g., the molecular weights of the compounds or the identity of the compounds) may also be included.

Instructions for practicing the methods are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging) etc. In other embodiments, the instructions are present as an electronic storage data file present on a suitable computer readable storage medium, e.g. CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions is recorded on a suitable substrate.

### EXPERIMENTAL

The following examples are put forth so as to provide those of ordinary skill in the art with a description of how to make and use some embodiments of the present invention, and are not intended to limit the scope of what the inventors regard as their invention.

### Example 1

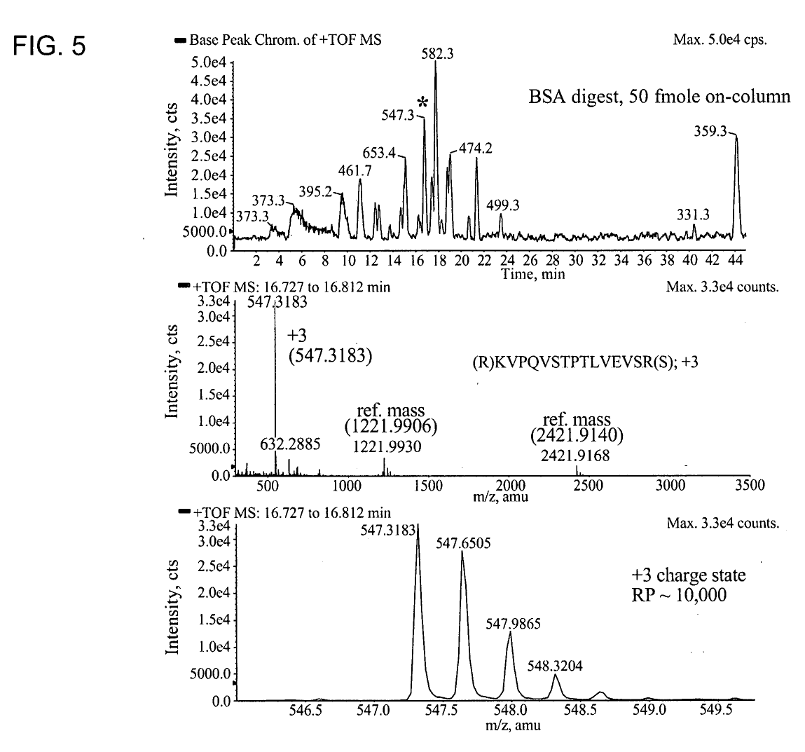

FIG. 5 shows exemplary positive ion mode results obtained using the multi-inlet sampling device in conjunction with an atmospheric pressure nanoelectrospray ionization source (modified Agilent G1982B) and a time of flight mass analyzer (Agilent G1969 API-TOF). The top plot is a base peak chromatogram identifying a number of extracted peptide ions obtained from analysis of 50 femtomole of a bovine serum albumin (BSA) tryptic digest (Michrom Bioresources, Auburn, Calif.). The lyophilized digest was reconstituted in 95:5 (v/v) water/acetonitrile with 0.1% formic acid prior to use.

An Agilent Technologies 1100 series nanoflow LC system (Agilent, Little Falls, Del.) provided solvent delivery and separations. 50 femtomole of the bsa digest was loaded onto a Zorbax 300SB-C₁₈ column (Agilent), 50mm×0.075 mm i.d. with 3.5 μm particle diameter and 300 Å pore size, maintained at 30° C. After equilibrating in mobile phase A (water with 0.1% (v/v), formic acid), flowing at 300 nl/min, mobile phase B, consisting of acetonitrile with 0.1% (v/v) formic acid, was used to elute peptides from the column via the following gradient: wash and equilibrate at 5% B for 6 min, step to 20% B and then ramp to 65% B over 19 min, hold 10 min, then ramp to 80% B over 10 min. The column was then re-equilibrated in 5% mobile phase B.

The LC effluent was introduced proximal to the primary inlet via sprayer 1. Sprayer 1 and the primary inlet correspond to the first sample sprayer and first inlet capillary in the device shown in FIGS. 1A and 1B. A solution containing two reference mass standards (0.1-1.0 μM concentration) in 95:5 (v/v) acetonitrile/water was introduced proximal to the secondary inlet via sprayer 2. Sprayer 2 and the secondary inlet correspond to the second sample sprayer and the second inlet capillary in the device shown in FIGS. 1A and 1B. A Cole-Parmer 74900 series syringe pump (Vernon Hills, Ill.) was used to infuse the reference mass solution at a low rate of 100 nl/min. Sprayers 1 and 2 utilized fused-silica PicotipTM emitters with 8 μm tip i.d., part number FS360-50-8-D-5 (New Objective, Woburn, Mass.).

The middle plot is a mass spectrum of a BSA tryptic peptide, residue A(437-451) having the amino acid sequence KVPQVSTPTLVEVSR, eluting at 16.75 minutes. The indicated peak at 547.3183 represents the peptide's measured (i.e. observed) mass of the monoisotopic molecular ion. The theoretical (i.e. calculated) value is shown in parentheses. The other two indicated peaks in the mass spectrum correspond to reference mass ions having theoretical masses of m/z 1221.9906 and m/z 2421.9140 respectively. Reference ion mass measurements are used by the data system to adjust the calibration of the mass axis—typically in real time. The bottom plot shows a molecular ion plot of the +3 charge state of the same BSA tryptic peptide, A(437-451), at a resolving power of 10,000.

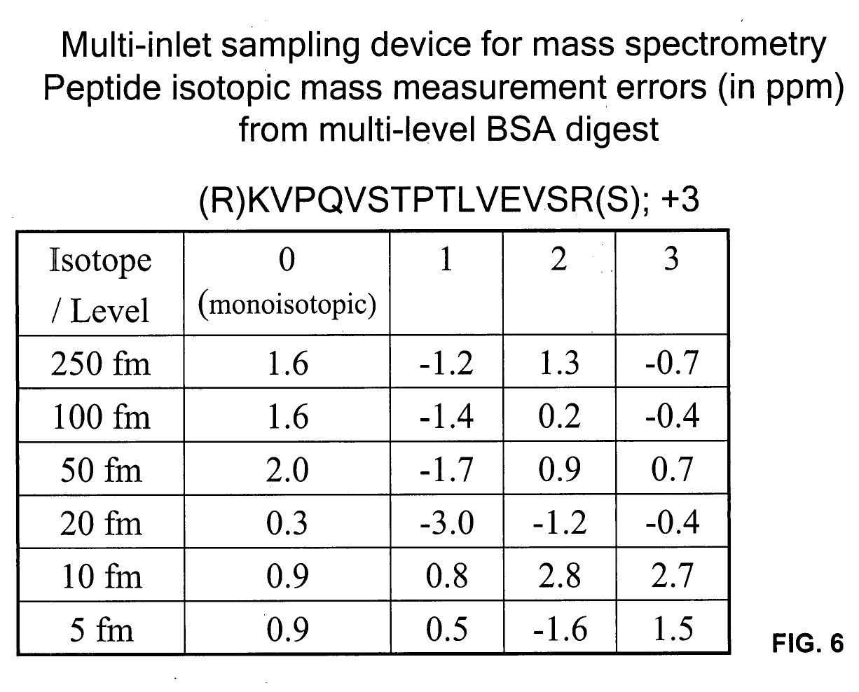

FIG. 6 contains a table of mass measurement errors (in ppm) for the first four istotope peaks of the molecular ion of BSA tryptic peptide A(437-451), +3 charge state, analyzed at multiple levels (5-250 femtomole on-column). The multi-inlet sampling device in conjunction with an atmospheric pressure nanoelectrospray ionization source (modified Agilent G1982B) and a time of flight mass analyzer (Agilent G1969 API-TOF) was used to analyze the sample as described above.

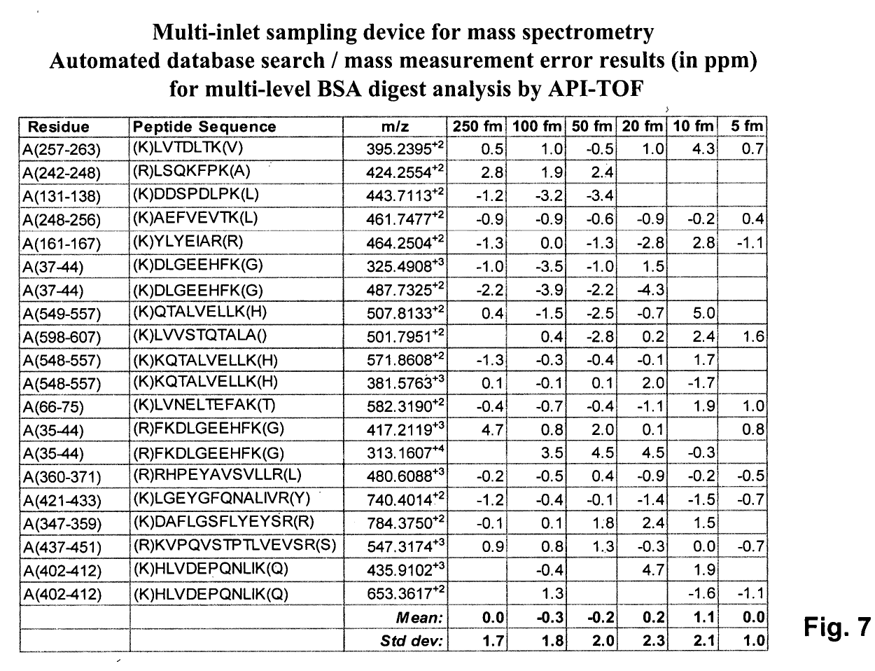

FIG. 7 shows exemplary results obtained for the analysis of a BSA digest at multiple concentration levels using the multi-inlet sampling device in conjunction with an atmospheric pressure nanoelectrospray ionization source and a time of flight mass analyzer. A BSA digest was analyzed at the 250, 100, 50, 20, 10, and 5 femtomole levels and mass measurement errors (in ppm) are reported in the table for a number of tryptic peptides identified by automated spectral data extraction software and protein database search tool (SPECTRUMMILL™) available from Millenium Pharmaceuticals, Cambridge, Mass.

Note: For the 250 fm level BSA tryptic digest analysis, mass measurement error values for three peptides were not reported by the SPECTRUMMILL™ software, however, the peptides are at detectable levels in the sample. The missing peptide molecular ions were manually extracted and are reported as follows:

Manually determined mass measurements errors (in ppm)
for non-reported BSA tryptic peptides analyzed at the 250 fm level

| | | Theoretical | Measured | Error |
|---|---|---|---|---|
| Residue | Peptide Sequence | m/z | m/z | (ppm) |
| A(598-607) | LVVSTQTALA | 501.7951⁺² | 501.7945 | −1.2 |
| A(402-412) | HLVDEPQNLIK | 435.9102⁺³ | 435.9091 | −2.5 |
| A(402-412) | HLVDEPQNLIK | 653.3617⁺² | 653.3610 | −1.1 |
| A(35-44) | FKDLGEEHFK | 313.1607⁺⁴ | 313.1633 | *8.3 |

*The large mass measurement error for this molecular ion species is most likely due to two factors: A less than optimal mass axis correction at low m/z and higher charge state (+4).

Polydimethylcyclosiloxane (5-mer) is a common system background contaminant and its ion (m/z 371.101233) was used along with the two reference mass standards (co-introduced via sprayer 2 to the second inlet capillary), to adjust the mass axis during data acquisition. In this case, the weak signal due to the contaminant sometimes resulted in less accurate mass measurements at low m/z. Co-introduction of a low mass reference mass standard along with one or more mid-to-high mass reference mass standards as described herein will generally result in improved mass accuracy measurements throughout the mass range.

Referring to FIG. 7, other non-reported mass measurement values for peptide molecular ions at or below the 50 fm level, can be attributed to their signal being below the practical limit of detection.

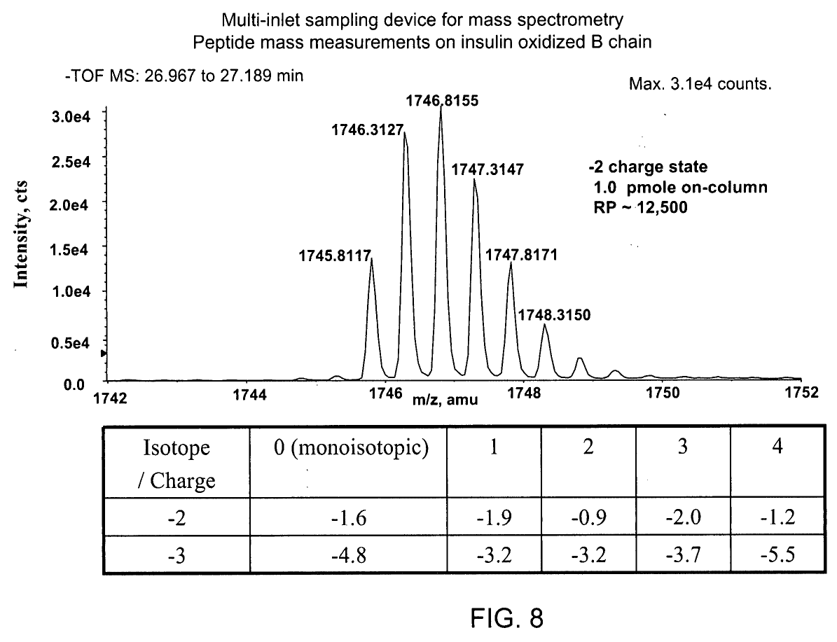

FIG. 8 shows exemplary negative ion mode results obtained using the multi-inlet sampling device in conjunction with an atmospheric pressure nanoelectrospray ionization source (modified Agilent G1982B) and a time of flight mass analyzer (Agilent G1969 API-TOF). 100 ug of lyophilized bovine insulin oxidized B chain was obtained from Sigma-Aldrich Fine Chemicals (St. Louis, Mo.) and reconstituted in 95:5 (v/v) water/acetonitrile with 0.1% formic acid. An Agilent Technologies 1100 series nanoflow LC system (Agilent, Little Falls, Del.) provided solvent delivery and separations. 1.0 picomole of the peptide was loaded onto a Zorbax 300SB-C₁₈ column (Agilent, Little Falls, Del.), 50 mm×0.075 mm i.d. with 3.5 ∞m particle diameter and 300 Å pore size, maintained at 30° C. After equilibrating in mobile phase A (water with 0.1% (v/v), formic acid), flowing at 300 nl/min, mobile phase B, consisting of acetonitrile with 0.1% (v/v) formic acid, was used to elute the peptide from the column via the following gradient: wash and equilibrate at 10% B for 5 min, ramp to 65% B over 15 min, hold 5 min, then ramp to 80% B and hold for 10 min. The column was then re-equilibrated in 10% mobile phase B. The LC effluent and reference mass solution were introduced in the same manner as described in above.

The upper graphic is a molecular ion plot of the −2 charge state of the peptide at a resolving power of 12,500. The lower graphic consists of a table of peptide mass measurement errors (in ppm) for the first four isotope peaks of the −2 and −3 charge states of the molecular ions.

Two reference mass anions (theoretical mass m/z 1265.9816 and m/z 2465.9049) formed by formate adduction to the corresponding neutral reference mass standards) were used by the data system to adjust the mass axis calibration in real time, as described earlier.

It is evident from the above results and discussion that the invention provides an important means for combining samples for mass analysis. Accordingly, the present invention represents a significant contribution to the art.

All publications and patents cited in this specification are herein incorporated by reference as if each individual publication or patent were specifically and individually indicated to be incorporated by reference. The citation of any publication is for its disclosure prior to the filing date and should not be construed as an admission that the present invention is not entitled to antedate such publication by virtue of prior invention.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A multi-inlet sampling device for an ambient pressure ion source, comprising:
a first sample inlet capillary having a first ion entrance port;
a second sample inlet capillary having a second ion entrance port; and
a single sample outlet capillary having an ion exit port;
wherein said capillaries are fluidically connected and said ports are at or near ambient pressure during operation of said ambient pressure ion source.

2. The multi-inlet sampling device of claim 1, wherein said multi-inlet sampling device is adapted for connection to a transfer capillary.

3. The multi-inlet sampling device of claim 1, wherein said multi-inlet sampling device is adapted for connection to an orifice in a wall of said ion source.

4. The multi-inlet sampling device of claim 1, wherein the inner diameter of said second sample inlet capillary is smaller than the inner diameter of said first sample inlet capillary.

5. The multi-inlet sampling device of claim 1, wherein said second sample inlet capillary has a sample flow rate that is at least 10 times lower than the sample flow rate of said first sample inlet capillary.

6. The multi-inlet sampling device of claim 1, wherein the inner diameter of said second inlet capillary is at least half of the inner diameter of said first sample inlet capillary.

7. The multi-inlet sampling device of claim 1, wherein said second sample inlet capillary has a diameter of about 0.2 to about 0.4 mm and said first sample inlet capillary has a diameter of about 0.6 to about 0.8 mm.

8. The multi-inlet sampling device of claim 1, wherein said first sample inlet capillary and said single outlet capillary are coaxially tandem and said second sample inlet capillary is at an angle thereto.

9. The multi-inlet sampling device of claim 1, further comprising a counter-current drying gas nozzle for at least one of said sample inlet capillaries.

10. A mass spectrometer ambient pressure ion source comprising:
a multi-inlet sampling device, comprising:
a first sample inlet capillary having a first ion entrance port;
a second sample inlet capillary having a second ion entrance port; and
a single sample outlet capillary having an ion exit port;
wherein said capillaries are fluidically connected and said ports are at or near ambient pressure during operation of said ion source; and
a first and second spray devices for delivering sample into said ion source at positions proximal to said first and second ion entrance ports.

11. The mass spectrometer ion source of claim 10 wherein said spray devices are oriented orthogonally to said inlet capillaries.

12. The mass spectrometer ion source of claim 10, wherein at least one of said spray devices is a nanospray device.

13. The mass spectrometer ion source of claim 10, wherein at least one of said spray devices is a microspray device.

14. The mass spectrometer ion source of claim 10 further comprising electrodes positioned such that said first and second spray devices are in close proximity to said inlet ports of said first and second sampling device inlet capillaries, respectively.

15. The mass spectrometer ion source of claim 10, wherein said ion source is an ESI, APCI, APPI or ICP ion source.

16. The mass spectrometer ion source of claim 10, wherein said ion source is multimode ion source

17. The mass spectrometer ion source of claim 10, wherein at least one of said spray devices has a flow rate in the range of 20 nl-5 ml/min

18. The mass spectrometer ion source of claim 10, wherein at least one of said spray devices has a flow rate of 100 nl-1 ml/min.

19. A mass spectrometer system comprising:
a) an ion source comprising a multi-inlet sampling device comprising:
a first sample inlet capillary having a first ion entrance port;
a second sample inlet capillary having a second ion entrance port; and
a single sample outlet capillary having an ion exit port;
wherein said capillaries are fluidically connected and said ports are at or near ambient pressure during operation of said ion source; and
a first and second spray devices for delivering sample into said ion source at positions proximal to said first and second ion entrance ports;
b) an orifice that is in fluid communication with the outlet capillary; and
c) a mass analyzer.

20. The mass spectrometer system of claim 19, wherein said orifice is an orifice of a transfer capillary or an orifice in a wall of said ion source.

21. The mass spectrometer system of claim 19, wherein said mass analyzer is a time of flight mass analyzer, a Fourier transform ion cyclotron resonance (FTICR) mass spectrometer, an ion trap mass spectrometer, a quadrupole mass filter or a hybrid thereof.

22. A method for introducing at least two samples into a mass analyzer, comprising:
a) ionizing at least two samples in an ion source;
b) introducing said ionized samples into a multi-inlet sampling device;
c) combining said ionized samples at or near ambient pressure within said sampling device to provide combined samples, and
d) exiting said combined samples from said multi-inlet sampling device at or near ambient pressure;
e) introducing said combined samples into a mass analyzer.

23. The method of claim 22, wherein one of said samples is a reference sample.

24. The method of claim 22, wherein said sample is a liquid chromatography system output.

25. The method of claim 22, wherein said sample is input into said ion source by a dispensing pump.

26. The method of claim 22, wherein said system is an high performance liquid chromatography, a micro-liquid chromatograph, ultra high pressure liquid chromatograph, a micro- or nano-liquid chromatograph or a capillary electrophoresis instrument.

27. The method of claim 22, wherein said samples are combined after they are introduced into said inlet capillaries and prior to exiting the sampling device.

28. The method of claim 22, wherein the gas flow rate of said outlet capillary is 0.05 l/min-10 l/min.

29. The method of claim 22, wherein the gas flow rate of said outlet capillary is 0.5 l/min-2.5 l/min.

30. The method of claim 22, wherein the liquid flow rate of said first sprayer is 280-320 nl/min and liquid flow rate of said second sprayer is 20-300 nl/min.

31. A kit, comprising:
a multi-inlet sampling device for an ambient pressure ion source, comprising:
a first sample inlet capillary having a first ion entrance port;
a second sample inlet capillary having a second ion entrance port; and
a single sample outlet capillary having an ion exit port; and
instructions for fitting said sampling device to an ion source.
